(19) United States
(12) Patent Application Publication
(10) Pub. No.: US 2003/0097195 A1
(43) Pub. Date: May 22, 2003

(54) Method for computing disassembly sequences from geometric models

(75) Inventors: Boris Yamrom, Bronx, NY (US); Maneesh Agrawala, San Francisco, CA (US); Russell Scott Blue, Clifton Park, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company, Niskayuna, NY

(21) Appl. No.: 09/683,115

(22) Filed: Nov. 20, 2001

(51) Int. Cl. G06F 19/00

(52) U.S. Cl. 700/95; 700/96; 700/97

(57) ABSTRACT

A method and system for generating at least one disassembly sequence from a geometric representation of an assembly. The method comprises selecting at least one part for removal from the assembly and generating the disassembly sequence for the part based on a plurality of pre-computed relational information from the geometric representation.

### FEDERAL RESEARCH STATEMENT

The US Government may have certain rights in this invention pursuant to contract number F33615-01-2-6000 awarded by the United States Air Force.

### BACKGROUND OF INVENTION

The present invention relates generally to systems for generating disassembly sequences. More specifically, the invention relates to computer implemented methods for generating disassembly sequences from geometric models to be used by field service personnel for training and the maintenance and service of products or machines in the field.

Computer aided design (CAD) has become an indispensable tool in the creation of modern industrial tools and machinery. CAD enables the creation of hard copies of various drawings of machine parts, as well as the ability to view and interact with three-dimensional (3D) representations (typically provided by the various commercially available CAD packages) directly on the computer display. Recently, more attention has been given to generating specifications of assemblies and assembly sequences to be used in assembly instructions. Generally, assembly sequences are difficult to describe with static images. Three-dimensional (3D) motion paths are more desirable. The generation of 3D motion paths has been generally accomplished, for example, by creation of animation sequences that depict the process of assembly. For large assemblies (several hundred parts) this is generally a daunting task. The efficacy of this approach is lessened by the human inability to hold in memory lengthy animation sequences. Exploded assemblies are used instead to convey, in static images, the various spatial interrelations between various parts in assembly. These images can aid not only in the initial assembly of machinery, but also in future repair and maintenance. Currently these images are produced manually by skilled draftsmen and are limited to small and medium size assemblies.

Maintenance instructions generally require disassembly instructions, and often require disassembly instructions to a given component or subassembly. Maintenance instructions do not necessarily require a complete tear down to the original list of components making up the assembly, but rather it is preferable to disassemble only to the level in the assembly needed to accomplish a given repair, replacement or other similar maintenance task. Typically, disassembly sequence generation cannot rely solely on CAD assembly packages described above, but rather requires a combination of computer-generated assembly sequences and human intervention to create and test the various disassembly sequences.

There is a need for a robust computer-implemented method for generating disassembly sequences from geometric models for use in field service maintenance and training of field service personnel.

### SUMMARY OF INVENTION

The present invention provides, in a first aspect, a method for generating at least one disassembly sequence from a geometric representation of an assembly. The method comprises selecting at least one part for removal from the assembly and generating the disassembly sequence for the part based on a plurality of pre-computed relational information from the geometric representation.

In a second aspect, the present invention provides a system for generating at least one disassembly sequence from a geometric representation of an assembly. The system comprises an engineering data generating device adapted to compute and provide engineering data relating to the assembly and a service sequence generator adapted to import and process the engineering data to generate the disassembly sequence responsive to selection of a part for removal from the assembly.

### BRIEF DESCRIPTION OF DRAWINGS

The features and advantages of the present invention will become apparent from the following detailed description of the invention when read with the accompanying drawings in which:

FIG. 1 is a block diagram illustrating a system for enabling field service of machines and training of field service personnel incorporating embodiments of the present invention;

FIG. 2 is flow diagram illustrating a method for generating a service sequence for use in the system illustrated in FIG. 1;

FIG. 3 is a block diagram illustrating a method for haptics enabled verification and validation of instructions useful in embodiments of the system illustrated in FIG. 1;

FIG. 4 is an illustration of an exemplary non-directional blocking graph (NDBG) useful in embodiments of the method illustrated in FIG. 2;

FIG. 5 is an illustration of an exemplary removal sequence useful in embodiments of the method illustrated in FIG. 2; and,

FIG. 6 is an illustration of an exemplary process flow of a method for generating a disassembly sequence incorporating embodiments of the present invention.

### DETAILED DESCRIPTION

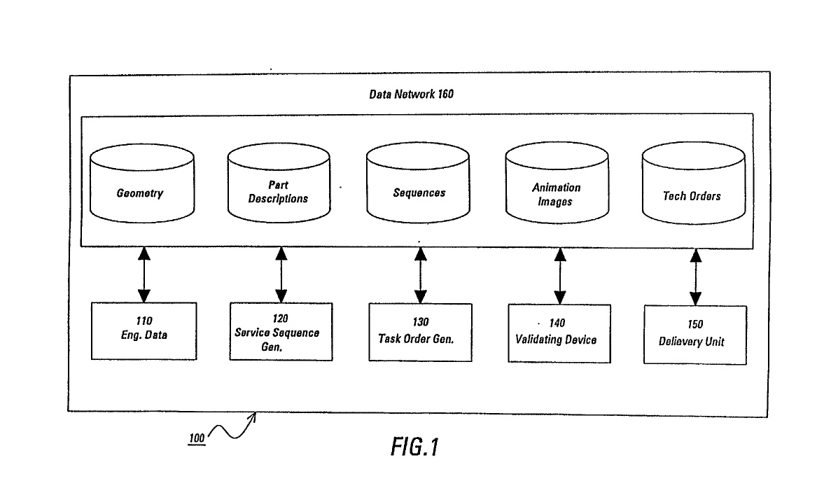

FIG. 1 is a block diagram of one example of a computing environment or system 100 incorporating and using the capabilities and techniques of the present invention for enabling field service of machines and training of field service personnel. Generally, machines requiring field service are of a type that remain at the field site, and are desirably serviced at a field site since it is generally not possible or desirable to return the machine to the place of manufacture. Examples of such machines are aircraft engines, weapon systems, other military equipment, medical imaging devices such as computed tomography (CT) machines, magnetic resonance imaging (MRI) machines, mammography machines, ultrasound machines, x-ray machines and other large field equipment such as power turbines, locomotives, and the like. Although the present invention is described in connection with military equipment and machines, the systems and methods of the present invention can be used and applied in connection with other electrical and mechanical machines, such as, for example, medical equipment, power generation equipment, automotive engines, appliances, power and utility service equipment and office equipment.

Referring to FIG. 1, system 100 is desirably maintained by or on behalf of a machine manufacturer or service provider and usable by field service personnel at a field site such as, for example, a military base or a hospital or medical center during installation, maintenance or repair of a machine. In addition, system 100 is included as part of a service contract with a customer such as, for example, a hospital or medical center for maintenance of medical machines based on a yearly or per visit fee arrangement.

System 100 comprises engineering data generator 110, service sequence generator 120, automated task order generator 130, validation unit 140 and instruction delivery unit 150. System 100 further comprises a data network 160 for storing various data, computation results and intermediate information generated by the various components of system 100. Each of the components of system 100 form part of a local area network or global communications network such as the Internet which comprises a vast number of computers, servers and computer networks that are interconnected through communication links. Further connections desirably include portable computers, such as personal computers of field service personnel, computer networks of field sites, video and computer workstations, and hand held computers. The above-described computing environment and computing units are only offered as examples. The present invention is capable of being incorporated and used with many types of computing units, computers, processors, nodes, systems, workstations and/or environments without departing from the spirit of the present invention. Further, various aspects of the invention are equally applicable to computing units that are remote from one another, computing units sharing a local network, computing units running on the same physical machine, different machines or any combination thereof. For example, the present invention is implemented on a portable computer or laptop computer wherein the engineering data is stored on a compact disc, or alternatively the engineering data is imported from a remote location via the Internet.

Engineering data generator 110 is adapted to compute and provide various forms of engineering data that are well known in the art such as, for example, computer aided design (CAD) geometry such as three-dimensional (3D) models, specifications, and engineering drawings. The various engineering data are typically created during the machine design phase. As used herein “adapted to”, “configured to” and the like refer to components having a structure (e.g. sensor) and a processing capability (e.g., with a programmable computer, Application Specific Integrated Circuit (ASIC), or the like) for performing a stated function. These terms also refer to mechanical or structural connections between elements to allow the elements to cooperate to provide a described effect. Further, these terms also refer to operation capabilities of electrical elements such as analog or digital computers or application specific devices (such as an application specific integrated circuit (ASIC)) that are programmed to perform a sequel to provide an output in response to given input signals.

Service sequence generator 120 is adapted to import and process the engineering data from engineering data generator 110 to perform a number of functions to generate service sequences, which will be described in greater detail below. As used herein, “service sequences” refer to operations and orders of operations needed for a particular maintenance or service task. Service sequences include disassembly sequences. In a first aspect, service sequence generator is adapted to create a disassembled view of the machine. The disassembled view is referred to as the exploded view in the art. Service sequence generator 120 is also adapted to generate a sequence of actions necessary for a particular maintenance task. Desirably, this sequence will be generated solely from the engineering data, for example the three-dimensional CAD geometry or other engineering data described above, for identifying the order of parts removal for efficient performance of the identified task. Known visualization systems exist which enable design engineers to view and manipulate large three-dimensional product assemblies. One such application is, for example, GE Product Vision, which enables engineers to create removal paths of assembly components by defining points in a three-dimensional environment, and an automated part path planner, which can find an interference-free removal path for a component. Other known design tools provide the engineers with the ability to view large data sets in a virtual environment. These tools generally use techniques to convert CAD solid models to tessellated representations, and further provide the ability to rapidly load large data sets and interactively navigate or “fly” around them to examine clearance and interference issues within a product assembly. An exemplary application is Galileo by General Electric (GE), which is typically used as a production visualization tool having an enhanced ability to view a large data set and also having the ability to create removal paths.

In an embodiment of the present invention, service sequence generator 120 is adapted to automatically generate the service sequences for the parts of the assembly and an exploded view for communicating the assembly intent. The automatic generation of service sequences is enabled upon import of the engineering data from engineering data generator 110. The service sequences are computed by service sequence generator 120 based on a plurality of pre-computed relational information between components of a given assembly, such as the mating interfaces between components of a machine and others, which will be described further. Information from three-dimensional engineering data and component positions and orientation in space determine all mating surfaces between components. In an embodiment, mating surfaces between each pair of components are generated by analyzing mutual spatial relationships between each pair of polygons taken from each component. This approach requires polygonal representation of the geometry, obtainable as output from commercial CAD and visualization tool packages. It is to be appreciated that other known surface representations, other than polygons, are alternate embodiments for computing mating interfaces. In a further embodiment, service sequence generator 120 is adapted to import and process the engineering data to generate at least one disassembly sequence responsive to selection of a part for removal from the assembly.

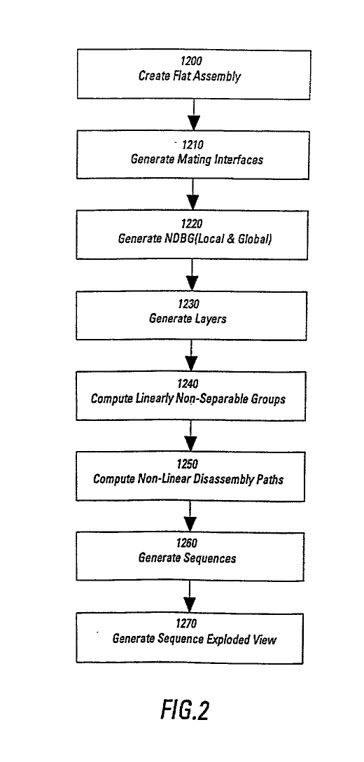

In a method of the present invention, it is desirable that substantially all possible sets of sequences for the explosion of the given assembly are considered. However, to consider all possible sets of sequences would be computationally extensive. Thus, service sequence generator 120 uses some heuristics to limit the set of sequences for the explosion. Heuristics, as used herein, refer to programmed rules and conditions for removal paths, and such conditions will be described with reference to FIG. 2. Use of heuristics limit the number of possible sequences from growing exponentially with the number of parts of the assembly, therefore avoiding extensive computations.

FIG. 2 illustrates a process flow diagram for an embodiment of a method for generating service sequences by service sequence generator 120 (FIG. 1). The method comprises the steps of creating a flat assembly 1200, generating mating interfaces at 1210, generating local and global non-directional blocking graphs (NDBG) at 1220, generating layers at 1230, computing linearly non-separable groups of parts at 1240, computing non-linear paths for disassembling groups generated in 1240 at 1250, generating sequences at 1260, and generating sequence exploded views at 1270. Each of the process steps will be discussed further below. As depicted in FIG. 1, every process step or subsystem stores the results of processing into and retrieves the necessary input data from data network 160.

Referring further to FIG. 2, at step 1200, a flat assembly is created. A flat assembly is a list of generally all parts in a given assembly. Each part has geometry, orientation and position information associated with it. Generally, subassembly structures are disregarded if they are presented in the CAD database. Typically, CAD tools provide subassembly information such as sub-groups of parts. However, considerations for removal paths and disassembly are desirably handled at the part level. An embodiment of flat assembly 1220 is a list of parts not including subassembly information from a CAD tool. In an alternative embodiment, this step creates a flat assembly which considers and includes top level subassemblies that are not divisible and may be treated as a unit during disassembly. In a further embodiment, both approaches may be used and the user determines the selection of either one.

At step 1210, mating interfaces are generated. Generally in this step, each part of a given assembly is a triangulated polygonal representation and each triangulated polygonal representation of the individual parts is used to generate triangulated surfaces representing mating interfaces between pairs of parts. To be computationally efficient this process computes distances between parts and proceeds with mating interface computations only if the distance is less than a specified threshold.

In an example, parts A and B represent individual parts of a given assembly. The mating interface between two parts A and B is a subset of triangles in one part (e.g. part A) that satisfy several threshold criteria. Since parts may not fit exactly to each other, generally the mating interface between parts A and B is not the same as the mating interface between parts B and A. Desirably, both mating interfaces are computed. The following criteria are the threshold criteria desirably employed to compute a mating interface:

1. The planes of the triangles are close to parallel.

2. Distances between triangles are less than a specified threshold.

3. Projection of triangle in part A on the plane of the triangle in part B overlaps the triangle in part B.

In an embodiment, mating interface computation 1210 evaluates the normal vectors to the triangles in both parts A and B and determines if there is an interface between the parts. To determine if there is an interface, the three threshold conditions above are evaluated for a given pair of triangles, for example one triangle from part A and another from part B. If all of the three threshold conditions are satisfied, then the triangle from model B is added to a mating interface. If not all of the threshold conditions are satisfied, then processing continues for another triangle pair. Processing continues in a double-loop fashion until all triangles from a first part are similarly processed with all triangles from a second part and added to the mating interface if the three threshold conditions are satisfied for a given pair. It is to be appreciated that known techniques to optimize the computations for mating interfaces are desirably employed. One such optimization techniques is, for example, the bounding box comparison technique. The mating interface represents the interface surface comprised of the triangles meeting the threshold conditions.

At process step 1220 of FIG. 2, local and global non-directional blocking graphs (NDBG) are generated. In this process step, mating interfaces generated above are further evaluated to determine movement constraints and interferences. Once the mating surfaces (polygons) are identified, normal vectors are applied to each in the mating surfaces' mesh. For each pair of components in the assembly that have nonempty mating interfaces, the interface normals are used to find the set of all feasible directions for moving one component from another without mutual collision. As used herein, a non-empty interface is a mating interface containing at least one polygon. Instead of considering the continuous space of all possible directions for explosion, the space of possible directions is desirably limited to a finite set of uniformly distributed directions. This finite set can be modeled by a finite set of points on a unit sphere; thus each point in the set corresponds to a normal vector. Using a discretized sphere and normal vectors-to-points on the sphere, and using the Boolean intersection of possible directions corresponding to each polygon in the mating surface, the possible directions of part movement without mutual collision are determined. As used herein, a discretized sphere is defined as a finite set of points uniformly spread on a unit sphere. The possible directions corresponding to one polygon represent a set of points on the discretized sphere that belong to a hemisphere opposite to polygon's normal vector. The possible directions corresponding to a set of polygons represent Boolean intersections of sets of possible directions corresponding to each polygon in the set.

A pair of parts, for example A and B, are in a blocking relation (constraint) relative to a specified direction, if the straight line motion of part A in this direction will cause collision of part A with part B. The notation for this would be d: (A,B). Here d stands for direction, and (A, B) denotes a constraining relation. If the collision occurs within a small finite distance, it is considered a local constraint, otherwise, it is a global constraint. Given a set of parts representing an assembly, a directional blocking graph (DBG) for a specified direction is a list of all blocking constraints among these parts relative to this direction. A union of DBGs for a set of multiple directions is called a non-directional blocking graph, or NDBG. Non-directional blocking graphs (NDBG”s) are algebraic representations of geometric constraints.

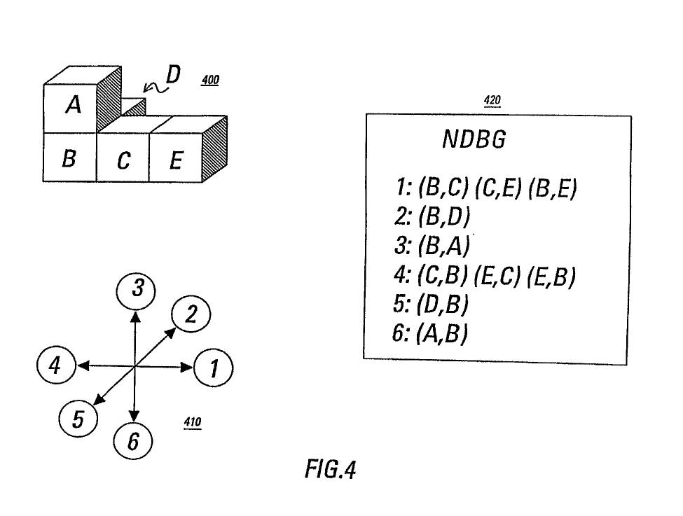

Referring to FIG. 4, there is shown a representative NDBG. An assembly 400 is shown with parts or components A, B, C, D and E. Directions 410 are shown as 1, 2, 3, 4, 5 and 6. A DBG and a NDBG can be local or global depending on what constraints are included (local or global). Referring to FIG. 4, components B and C, C and E, and B and E are listed as component pairs in direction 1. Thus, components B and C are in a product assembly such that B blocks C in a given direction, therefore the pair (B,C) is inserted in that directional blocking graph. Similarly, the pairs (C,E) and (B,E) are added for direction 1. Here (B,E) is a global constraint. Multiple directional blocking graphs are similarly defined for other given directions, as defined by a discretized sphere. The non-directional blocking graph is obtained by merging all directional-blocking graphs for all directions represented by the discretized sphere. It is to be appreciated that direction and paths are automatically determined, or alternatively pre-determined, for some parts that are otherwise not computed to be part of the discretized sphere. For example, a cylinder (such as a bolt) in a hole will have a very specific removal direction that might not be contained in the discretized sphere. Desirably, the methods of the present invention will make computations needed to accommodate directions/paths that are not covered by the discretized sphere calculations.

In a further embodiment, part connectivity information (parts are connected if there is a non-empty mating interface between them) is also stored as a result of the mating interface and NDBG generation steps. Connectivity, as used herein, refers to the condition of parts having a physical connection. It is to be appreciated that connectivity information is useful for various aspects of part and assembly model manipulations. Given a group of parts of an assembly, the connectivity information can be used to define connected components in the group of parts.

The number of possible assembly sequences consistent with the non-directional blocking graph generated grows exponentially in the worst case as a function of the number of components. As stated above, in practice, a subset of the possible assembly sequences are desirably generated. Therefore, it is desirable to capture in programmatic rules additional constraints, or alternatively heuristics, that will reduce the number of possible sequences. Heuristics are also useful to capture real world constraints, for example preventing objects from floating in space a condition that is possible when using CAD tools but not possible in actual disassembly. Analysis and classification of industrial assemblies are performed to generate heuristics for the assembly sequence selection. Generally, the first candidates for analysis are symmetry constraints. Symmetries are automatically extracted from CAD models. Alternatively, another way to reduce the number of possible assembly sequences is visual analysis of the assembly such that the user selects part groups. These groups may be considered as user specified symmetries. This approach does not require specification of assembly hierarchy by the user, but if one is provided, it can be validated and used for service sequences and exploded views. A further alternative for reducing the number of possible sequences is using connectivity information. Thus, in an embodiment of the present invention the service sequence generator employs heuristics and programmatic rules as described above.

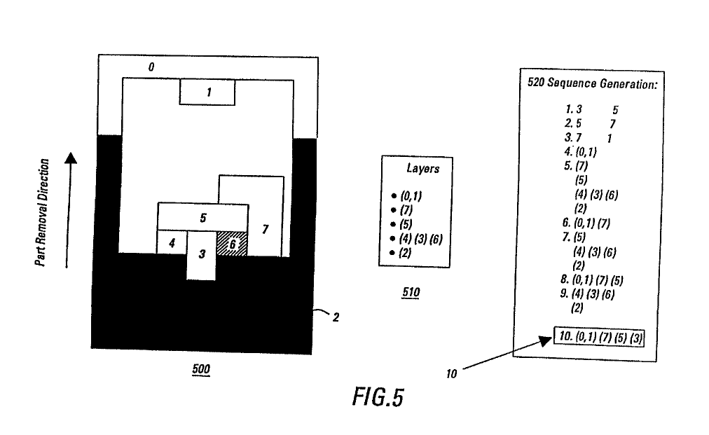

Referring further to FIG. 2 at step 1230, layers are generated. As used herein, layers refer to a grouping of parts. For the purposes of the present invention, layers are numbered 1, 2, . . . , and more specifically refer to groupings of parts that can be removed from the assembly without colliding with other parts in the same and all following layers. Also, as used herein, layers refer generally to the data sets of parts or groups of parts that are processed during the service sequence generation process. The layers include relative ordering of parts within a given assembly and grouping information. For example, parts in layer 1 can be removed from the assembly without colliding with all other parts. Parts in layer 2 can be removed without colliding with parts in layer 2 and parts in layers 3, 4, . . . , etc. Additionally, layers provide a removal order for some parts. As used in this context, parts and groups of parts are located in the layers. Identifying groups of parts at a given layer enables partial disassembly when it is not necessary to disassemble every group of parts. Referring to FIG. 5, there is shown an example of layers in two dimensions (2D). Assembly 500, is made of parts 0 through 7. Layers are generated to be used to create a sequence (shown as 10 in sequence generation 520 of FIG. 5) for part removal in a given direction, based on information such as mating interfaces and the NDBG. For the example in FIG. 5, the part removal direction is upward and multiple layers 510 are shown. The parts 0 and 1 are shown as (0,1) to indicate they are a part group within a given layer. Parts 0 and 1 are grouped in this example since removal of part 0 by itself would leave part 1 unconnected to any other parts, or “floating in space”. Part 7 is next, since it must be removed to allow the next layers to be removed. Part 5 is shown in the next lower layer. Thereafter, the layer containing parts 4, 3 and 6 specifies that any of the parts may be removed in no particular order. Finally, part 2 represents the last or innermost layer in the given direction. It is to be appreciated that the teachings provided by the 2D example are equally applicable to higher dimensions and multiple removal directions. In order to generate layers in step 1230, the following conditions, and alternatively a subset of the following conditions, are desirably employed:

1. Every part belonging to a given layer is removable from the assembly of parts, excluding parts in all previous layers.

2. If at some point during generating layers, any single part cannot be removed without collision with the remaining parts, then it is attempted to remove groups of parts until at least one group can be removed.

3. If the second condition fails or there are no parts left in the assembly, processing stops;

Optional conditions that may be employed when generating the layers are:

1. When removing a part or group of parts, none of the remaining parts are caused to be “floating in space”;

2. When creating a group of parts for removal, the group should be completely connected; every part in the group should be connected to (have a mating interface with) every other part in the group, either directly or indirectly through other parts within the group.

The previous process steps that have been described are generally applicable to straight-line removal paths. In the course of maintenance and repair, often removal paths are not straight-line translations. In an embodiment of the present invention, at step 1240, linearly non-separable groups of parts are computed based on the generated layers in order to determine groups of parts that cannot be separated by straight-line translations. As a result of applying this process step to an input assembly, groups of parts are identified that contain a list of linearly non-separable groups of parts.

At step 1250, non-linear paths for disassembling parts within the groups generated in 1240 (linearly non-separable groups) are computed using any of various known path-planning techniques, e.g. user interaction, haptics, automatic path planning.

At step 1260, disassembly sequences for each part in the assembly are generated and stored. For the convenience of describing step 1260, it is assumed that there are no linearly non-separable groups of parts. If such groups exist, it is to be appreciated that the step can be modified based on the existence of computed and stored nonlinear path removal sequences generated by step 1250.

In an embodiment of the present invention, a method for generating at least one disassembly sequence from a geometric representation of an assembly is provided. The method comprises selecting at least one part for removal from the assembly and generating the disassembly sequence for the part based on a plurality of pre-computed relational information from the geometric representation. The pre-computed relational information comprises at least one of: mating interfaces between respective parts of the assembly (as computed at step 1210 of FIG. 2); non-directional blocking graphs (as computed at step 1220 of FIG. 2); and, relative part and group ordering within the assembly (layers as computed at step 1230 of FIG. 2). The generation of disassembly sequences is desirably a recursive process wherein each part, group of parts, generated layers, removal paths, and the NDBG are evaluated to determine a complete disassembly sequence. As a result of this process step, a disassembly sequence is represented as a sequence or list of removal steps. Removal steps may include a single part or a group of parts. The disassembly sequence also desirably specifies a disassembly order.

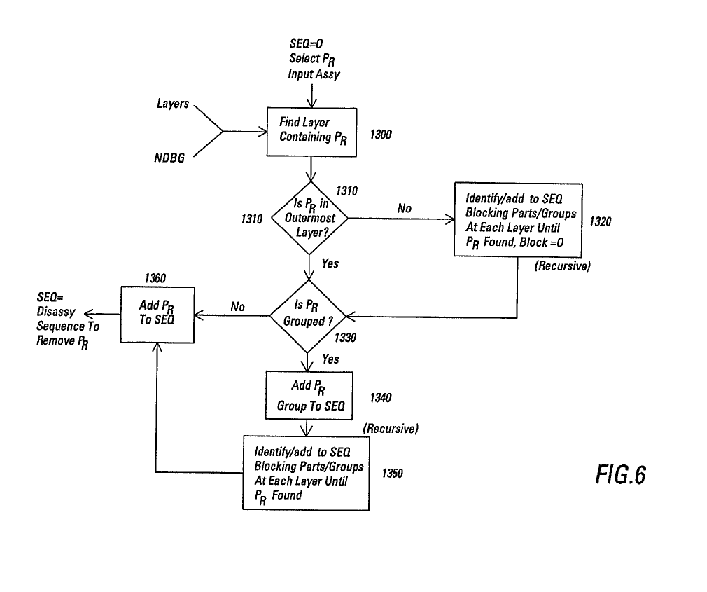

Referring to FIG. 6, an exemplary embodiment of a method for generating disassembly sequences is shown. It is to be appreciated that the embodiment illustrated in FIG. 6 is a flow chart representation for exemplary purposes only, and modifications and adaptations in various computer coded representations would not depart from the spirit of the invention.

Referring to FIG. 6, an embodiment of a method for generating a disassembly sequence for an assembly is shown for a given part P_{R,} selected for removal for a given service task. The process shown in FIG. 6 is performed for each part (or group of parts) selected for removal within an assembly, and it is to be appreciated that the process can be repeated for as many parts, or sets of parts within the assembly as desired. Each process step will be described in greater detail below.

For a selected part for removal P_{R} from a given assembly, generally the following inquiries and processing steps are performed:

1. Compute the layers for the assembly.

2. Determine if P_{R} is in the outermost layer, either as a part or contained within a group of parts in the outermost layer.

3. If P_{R} is not in the outermost layer, then identify the blocking parts or groups of blocking parts impeding removal of P_{R}.

4. Continuously add the identified blocking parts and groups of blocking parts to a disassembly sequence until P_{R} is found and removed as desired.

Referring further to FIG. 6, for a given part (or group of parts) P_{R,} an input assembly and an empty sequence structure SEQ, a recursive method for generating a disassembly sequence is desirably described as follows:

The initial inputs are a part P_{R} to be removed and the assembly to remove the part from (hereinafter “input assembly”). The layers pre-computed at 1230 of FIG. 2 and the NDBG pre-computed at 1220 of FIG. 2 provide the relational information to enable generation of a disassembly sequence from a geometric representation.

As shown in FIG. 6 at step 1300, for a given P_{R}, processing finds the layer containing P_{R}. A query at 1310 determines if P_{R} is in the outermost layer of the assembly. If P_{R} is not within the outermost layer, further processing at step 1320 is performed recursively to identify blocking parts at each layer impeding removal of P_{R}. Step 1320 is discussed in greater detail below. If P_{R} is in the outermost layer, then a query at 1330 is made to determine if P_{R} is part of a group. If P_{R} is in a group within the outermost layer, then the group containing P_{R} is added to the removal sequence (1340). Further recursive processing is performed at 1350 to generate a sequence to remove P_{R} from the group. Blocking parts that impede removal of P_{R} are identified and added to the sequence at step 1350. Once P_{R} is found, either in the outermost layer at 1310 or after processing through layers containing blocking parts at 1320 or after processing blocking parts within a group of parts containing P_{R} at 1350, then P_{R} is added to the sequence. Thus, a disassembly sequence SEQ is constructed so that P_{R} can be identified and removed on its own.

At step 1320, when P_{R} is not in the outermost layer of the input assembly, processing is performed recursively to remove parts and groups of parts that are blocking removal of P_{R}. For each given part or group of parts blocking P_{R}, processing treats the blocking part/group as the removal part. If it is determined that the blocking part or group is in the outermost layer, then the part/group is added to the removal sequence and then removal of the part blocked by that part/group is re-attempted. When the blocking part is not in the outermost layer, then the recursion continues until a blocking part/group in the outermost layer is found. It is generally only necessary to remove the blocking group in order to allow removal of P_{R}, the removal part. Referring to FIG. 5, an exemplary method for generating a disassembly sequence is illustrated.

Referring first to FIG. 5, the part selected for removal is part 6. As is shown in FIG. 5, the blocking parts are 5, 7, 1, and 0. The layer containing part 6 is not in the outermost layer, and found to be in layer 4. Recursive processing first identifies 5 as blocking 6, then 7 as blocking 5, and finally (0,1) blocking 7. To remove the blocking parts, processing thus identifies part group (1,0) in the outermost layer and adds the group to the removal sequence. Thereafter, once (1,0) group is removed, part 7 is considered in the outermost layer and part 7 is similarly added to the removal sequence. Finally, blocking part 5 is identified in the outermost layer of the remaining assembly and part 5 is added to the disassembly sequence. Once the disassembly sequence has removed group (1,0), part 7 and part 5, then the selected removal part 6 is considered in the outermost layer and is added to the disassembly sequence.

Finally at step 1270, an exploded view of the disassembly sequence is generated for the purposes of use in maintenance and service of the field equipment. The disassembly sequence generated above at step 1260 is the input data for this process step. An exploded view is a representation of the disassembly including computed displacement distances along a part removal direction for each part in the disassembly sequence. Desirably, during the exploded view generation displacement distances are computed such that none of the parts or groups of parts in the disassembly sequence collides with other parts. An exploded view displays the disassembly with all parts in the sequence placed according to the computed distances. In a first embodiment, the exploded view is desirably displayed to field service personnel and their personal service equipment. In this embodiment, service personnel are able to change the position, orientation, and view angle to create images that convey the assembly structure. In further embodiments, if desired, the images resulting from the exploded view generation are printed copies for incorporation into service manuals.

The sequence of actions generated as described above is desirably output in a form acceptable to the automated task order generator 130, and thereafter converted by automated task order generator 130 into understandable assembly/maintenance instructions. Simple actions will be defined for each part, such as position, move, turn, etc. along with the part identity, distance, and direction of motion for the explosion. Generally the order of removal/assembly is relevant for maintenance tasks. Therefore, the order in which these actions are input to the automated task order generator are assumed to be the order in which they will be performed by a maintenance technician.

Automated task order generator 130 is adapted to produce a set of clear and concise instructions in natural language, written or spoken, that could be followed step-by-step by a service technician to perform a specific maintenance task. A maintenance task usually involves removing certain parts from an assembly in order to replace them or to reach other parts.

Natural language generation is a sub-field of computational linguistics and artificial intelligence research devoted to studying and simulating the production of written or spoken discourse. The study of human language generation is a multidisciplinary enterprise, requiring expertise in areas of linguistics, psychology, engineering, and computer science. Generally, natural language generation technology is the study of how computer programs can be made to produce high-quality natural language text from computer-internal representations of information. Natural language generation is often characterized as a process that begins from the communicative goals of the writer or speaker, and involves planning to progressively convert them into written or spoken words. In this view, the general aims of the language producer are refined into goals that are increasingly linguistic in nature, culminating in low-level goals to produce particular words. Usually, a modularization of the generation process is assumed, which roughly distinguishes between a strategic part (deciding what to say) and a tactical part (deciding how to say it). This strategy-tactics distinction is partly mirrored by a distinction between text planning and sentence generation. Text planning is concerned with working out the large-scale structure of the text to be produced, and may also comprise content selection. The result of this sub-process is a tree-like discourse structure that has at each leaf an instruction for producing a single sentence. These instructions are then passed to a sentence generator, whose task can be further subdivided into sentence planning (i.e. organizing the content of each sentence), and surface realization (i.e. converting sentence-sized chunks of representation into grammatically correct sentences). The different types of generation techniques can be classified into four main categories: 1) canned text systems; 2) template systems; 3) phrase-based systems; and, 4) feature-based systems.

Canned text systems constitute the simplest approach for single-sentence and multi-sentence text generation. Template systems rely on the application of pre-defined templates or schemas, and are able to support flexible alterations. The template approach is used mainly for multi-sentence generation, particularly in applications whose texts are fairly regular in structure. Phrase-based systems employ generalized templates. In such systems, a phrasal pattern is first selected to match the input, and then each part of the pattern is recursively expanded into a more specific phrasal pattern that matches some sub-portion of the input. At the sentence level, the phrases resemble phrase structure grammar rules; and at the discourse level they play the role of text plans. Feature-based systems represent each possible minimal alternative of expression by a single feature. Accordingly, each sentence is specified by a unique set of features. In this framework, generation consists of the incremental collection of features appropriate for each portion of the input.

An embodiment of automated task order generator 130 includes a hybrid approach combining several of the above techniques. Task order instructions follow a fairly regular structure that makes the tactical generation part relatively more constrained than would be the case with a more open-ended applications, e.g., news reporting. Task order instructions are multi-sentence and multi-paragraph texts that require discourse level generation capabilities to address text coherence and readability issues. The strategic generation part (what to say) is partially given by the service sequences representation. However it does not address the issue of granularity of the final instructions, which has to be decided before tactical generation begins. Clearly, different levels of detail may be acceptable, even desirable, depending upon the nature of maintenance task and the expected level of expertise of the service personnel.

As described above, the exploded view representation defines possible removal paths for various parts and sub-components of an assembly. These paths are described in terms of geometric functions that track three-dimensional coordinates of each point of the moving parts. These paths need to be mapped onto sequences of elementary motions that can be described using natural language expressions from existing and emerging systems of semantics in order to design a representation language suitable for describing motions and relationships of parts in an exploded view. For example, a straight-line motion of a part can be expressed as a primitive action MOVE:

MOVE(P1,D1,DIR)

where P1 stands for the part, D1 specifies the distance,

and DIR gives direction with respect to some global coordinates (e.g., 30° NE). Similarly, a circular motion can be described using a primitive action TURN:

TURN(P1,DIR,DEG)

where DEG is the degree (positive or negative). Other such actions will be defined as required. It is to be noted that the primitive actions must be such that a human operator can perform them. For example, if a part is to be removed using a motion along a curve, this operation is desirably described giving straight-line direction from a start point to an end point, possibly with additional qualifications to follow the shape of an available passage. In addition, basic states of moving parts with respect to some global coordinates are desirably provided, as well as with respect to other parts. For example, POSITION(P1,X,Y,Z) may describe absolute three-dimensional coordinates of part P1. Such position description will be generated whenever a change of motion occurs. For example, when a circular motion changes into a straight-line motion, a state primitive (i.e., not derived but the primary basis of the position description) is inserted to capture the position of the part at that moment. The state primitive will serve later to define boundary conditions for both the preceding and the following motion predicates, so that a human-readable instruction can be obtained, e.g., turn the knob counter clockwise until it can be removed. States describing parts relationships to other parts and to the rest of the assembly are captured as well. For example, a meta-operator (i.e., an operator that is more comprehensive or transcending): ENABLED(A1) where A1 denotes a primitive action, such as MOVE or TURN, simply says that action A1 can be performed as described. Similarly, DISABLED (A1) indicates that action A1 can no longer be continued, perhaps as a result of a moving part encountering an obstacle on its way. This information can be obtained from the blocking graph, which is part of the exploded view representation. Other states will be defines as needed. It is to be appreciated that even this minimal set of primitives can be used to express a variety of instructions. For example, the instruction “turn the knob clockwise until you feel resistance” is described as follows: if A1=TURN(K1,CL,X>0) & ENABLED(A1) then TURN(N1,CL,X) until DISABLED(A1). Language of primitives has been a popular method for expressing meaning of natural language statements.

Automated task order generator 130 translates the exploded view representation of part removal from an assembly from service sequence generator 120 into natural language instructions that a human technician can understand and follow in order to verify their validity. This translation process proceeds in two automated steps: 1) translating the exploded views geometric representation into a sequence of primitive actions and states, and 2) synthesizing human-readable instructions from the primitive language sequence. In general, the translation process consists of the following steps:

a. Segmenting the removal paths—The removal paths for parts in the exploded views are divided into segments, such that each segment can be described by a single primitive action followed by a description of a basic state.

b. Supplying action parameters—Motion coordinates for each segment are converted into primitive action parameters, e.g., from here to there.

c. Supply human position and actions—The position and actions of the human operator are inserted into the sequence. Before an action can be performed, a technician may have to position himself or herself properly with respect to an assembly. This is also important for generating coherent and understandable natural language instructions, e.g., move to the right.

Automated task order generator 130 converts sequences of primitive actions into human-readable instructions. These instructions must be clear and concise so that a technician performing verification can understand and execute them. The conversion process involves translating sub-sequences of primitive actions into natural language commands and other supporting expressions. Normally, predicates such as MOVE or TURN, along with directional parameters will be translated into verbs and verb groups, e.g., pull or push down firmly. Parameters denoting objects will be translated into noun phrases, e.g., red bolt. Primitive action predicates of single primitive actions or sequences of primitive actions are desirably translated into verb groups. These verb groups denote specific actions to be performed by the human technician on an assembly, e.g., pull to the right. Primitive action parameters are desirably converted into noun phrases that uniquely identify objects and parts to a human technician, e.g., the square-headed bolt. Certain sequences of primitive actions that apply to the same object may be reduced to meta-actions that are commonly understood by human readers. For example, TURN(BB1,CCL,z) until ENABLE(MOVE(BB1,d1,d2)) may produce a natural language instruction of unscrew the blue bolt, rather than a more direct turn the blue bolt counterclockwise until it can be removed. Whenever necessary, supporting instructions for the human technician are supplied. These include positioning instructions (e.g., face the assembly so that the red handle is to your left), as well as performance instructions (e.g., firmly grasp the red handle). These instructions are desirably derived from the assembly orientation coordinates supplied with the service sequences from service sequence generator 120, as well as from the data available about parts (weight, size, etc.). These supporting instructions serve as linguistic devices to help the human technicians orient themselves as they perform the validation process.

Desirably, in order to increase readability of a task order sequence, discourse level cohesiveness devices are included in the instructions. For example, if adjacent commands are relating to the same part, it will enhance the overall readability of the instructions if an anaphoric reference is used instead of repeating the full part description. For example, “Turn the small red handle clockwise until resistance is encountered, then pull it firmly to remove” is clearly preferred to “Turn the small red handle clockwise until resistance is encountered. Pull the small red handle firmly. Remove the small red handle.”

Both the sequence of events generated by service sequence generator 120 and instructions generated by task order generator 130 are validated to ensure that the instructions can be carried out by a human operator. Desirably validation is performed after service sequence generation by service sequence generator 120 and after task order generation by task order generator 130. In a first aspect, the generated sequence is validated. The purpose of this validation is to establish that a human will be capable of performing a given service event, given that his arm and tools will be in the equipment as well. Human factors needing verification include ability to reach and grasp parts (using hands or tools), ability to perform certain motions (such as turning and pulling), as well as other factors that may limit a person's ability to carry out required sub-tasks, e.g., weight, length, or visibility of components. In an embodiment of system 100, validation unit 140 validates the sequence generated by service sequence generator 120 and provides any needed feedback to service sequence generator 120 such that service sequence generator 120 produces a feasible sequence. In a second aspect, the generated natural language task instructions are validated. A primary purpose of this validation is to establish that the instructions are clear enough to allow the human to understand which parts need to be removed and in what order and with what tools. Additionally, this validation may further validate human factor considerations described above. Conditions are supplied to validation unit 140 that are verifiable within the range of normal human sensory abilities. For example, while it may be acceptable to turn the knob approximately 30° clockwise, it is not reasonable to specify an exact number, e.g., 37°. If exact distance values are critical to perform a procedure successfully, alternative end conditions are desirably supplied, e.g., turn the knob until the notch aligns with the blue line. When the information is available in the exploded view sequence or in the primitive action sequence, an approximate or alternative wording is used to convey the desired meaning. When no such information exists, the task order instructions may be modified or enhanced for insertion of non-geometric information or additional features for reference in the task order instructions, e.g., painting a blue line on the part's surface and referencing the blue surface with the modified instructions.

Instructions generated from automated task order generator 130 are verified by validation unit 140. In an embodiment of the present invention, validation unit 140 is adapted to verify that the resulting natural language instructions generated by task order generator 130 can be carried out by a human technician. The methods and techniques described in the preceding sections create virtual removal paths for all serviceable parts of an assembly, but it does not guarantee that such removals can be physically performed or understood by a human. In order to support human verification, the service sequences and removal paths are converted into clear, concise natural language instructions for the human technician. The technician verifying a procedure will perform the steps as specified in the instructions. If the procedure can be carried out successfully, the verification is achieved. Otherwise, the cause of failure is identified and fed back into the system. If the failure occurs from vague, inconsistent, incomprehensible, or impossible to carry out instructions, the generation process is then repeated until a verifiable procedure is created. The language generation process ultimately produces English instructions, for example, but it could be adapted to other languages by substituting appropriate lexical realization components. Furthermore, the generation process is extendible to multimedia presentations, e.g., three-dimensional animation with a voice-over.

Written instructions, with graphics and context information, are used by human technicians to verify a task order sequence in a virtual environment and typically require the technician to constantly move their eyes between the text and the assembly. This may be disadvantageous under certain conditions, for example, when operating in narrow spaces. In another embodiment of the present invention, validation unit 140 is adapted to convert the written instructions into spoken commands that can be read to the operator one step at a time. This conversion is desirably accomplished using text-to-speech (TTS) technology, augmented with a speech recognition system (SRS) that understands simple commands such as repeat, done, next, go back, etc. Exemplary systems include TTS systems from Lernout & Hauspie, Lucent and Elan, as well as limited vocabulary SRS products from Lernout & Hauspie, IBM, Nuance, Phillips and others.

In a further embodiment of the present invention, validation unit 140 is adapted to utilize 6 degree of freedom haptics force-feedback technology to enable engineers to assess designs in a virtual environment. The haptics technology allows designers to virtually “grab” parts in an assembly and attempt to remove the part to determine if the maintenance action is feasible. Haptics is the field of tactile feedback in which a resistance force is applied in response to and against a user-initiated movement, which thereby imparts a sensation of touch to the user. By programming a computer with the space, surface, and location parameters of a predetermined space and/or object, a user of a haptic interface can simulate or model a sensation of “feeling” a particular object or manipulating the object in space without actually touching the surface or the object itself.

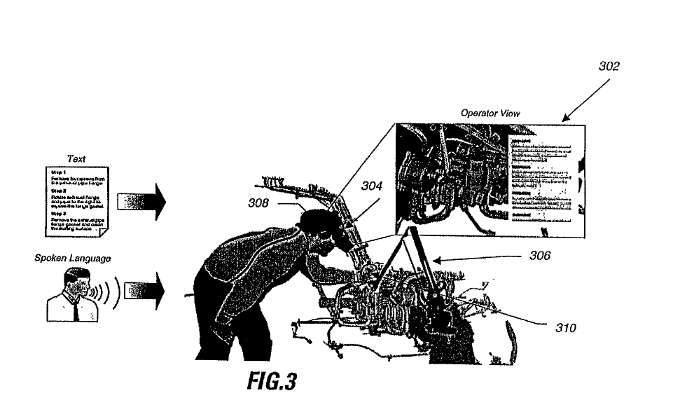

The haptic interface actually includes a broader range of equipment than is typically associated with a computer interface. FIG. 3 shows a typical haptic interface system that includes a computer or processor with memory (not shown) for storing space, location, and resistance data associated with a given object(s) or space. Connected to the computer is a display screen 302 for viewing the manipulated object in virtual space. The user 308 grasps a haptic device 306, which is typically an articulated arm with sensors to detect three directions of movement and three axes of rotation, also known as six degrees of freedom. Therefore, when user 308 manipulates the object in virtual space by moving haptic device 306, the sensors detect the combined movement in the six degrees of freedom, communicate the movement to the computer, which in turn translates the haptic device movement into movement of the object as displayed on the screen 302. The virtual effect of the object movement can be viewed by user 308 on the display screen 302 or, alternatively, through a user headset with goggles 304. As the object is moved in virtual space towards another object by operation of the haptics device 306, the computer detects when the relative spaces occupied by the objects coincide, thus detecting a collision, and directs the motors in the haptic device 306 to resist further movement by user 308 in the direction of the collision, thereby providing tactile feedback to the user 308 that the objects are in virtual contact. A data glove 310 is also desirably included in a haptics interface for tracking hand position in the virtual environment.

In an embodiment, a visualization front end is employed that allows the user to define a “haptic” workspace comprised of static or non-moving parts, as well as the removable part (or assembly of parts). Once this workspace is identified, the data is preprocessed to generate the structures necessary to perform collision detection at the rate required by the haptic device. In employing other embodiments of the present invention, a person doing the virtual validation will be substantially automatically enabled without having to define such a haptic workspace. Thus, the person doing the virtual validation will indicate the next part to be removed, for example by pointing at it in virtual space (using the data glove), wait for the computer to prepare the haptic experience for that part, then reach out again, grabbing the haptic device/virtual part and removing it. For the forces to be realistic in the haptic environment, they require an update rate of about 1 thousand times per second. Therefore, collision detection (including collision locations) must be performed at a significantly faster rate, making known typical polygonal collision detection techniques inadequate. A method for accomplishing the required collision detection rates is described as follows. The three-dimensional CAD models are pre-processed to generate a volume to represent the nonmoving, static parts and a set of points to represent the moving part (or assembly) in the haptic environment. The basic method for collision detection is to transform the moving part (points) into the static parts (volume). The collision detection rate requirement is met by transforming only the points that may be in collision into the volume, based on knowledge gained from previous collision tests and constraints imposed on how fast the moving parts can be moved.

In a further embodiment of the present invention, validation unit 140 is further adapted to provide the ability to have an interactive session in which multiple parts are extracted from an assembly. Known haptics systems are limited in that one part (or assembly) removal per haptic workspace is permitted. In this embodiment of the invention, a maintenance technician is able to seamlessly follow maintenance instructions from the natural language engine. With known haptics systems, the conversion of CAD geometry into multiple part/assembly removal workspaces is computationally intensive, requiring modification every time a part is added or removed. For example, if parts A, B, C, and D comprise a component, and A is to be removed; then B, C, and D make up the static environment represented by the volume. Once part A is removed, and if the instructions state part C should be removed, then part C becomes the “moving” part and the static environment is comprised of parts B and D. The known systems generally require loading of another workspace or re-computation of the region affected by part A, both requiring time and limiting the ability of the maintenance technician to remove parts in an order other than specified by the instructions. This situation becomes magnified when tools are continually inserted and removed from the environment, because they switch back and forth from being part of the moving part and fixed environment. In this embodiment, the technician is desirably permitted to remove parts in a random order. Further, the technician will have the ability to identify better ways to do the tasks, as well as identify instructions that are difficult to understand (by accidentally doing things in the wrong order).

To allow multiple part removal, one option is to build a database of the static volumes for each piece part in the virtual product assembly. For a given procedure, the static volume could be built much more quickly than is currently done by simply comparing the samples from the individual volumes. However, this alone would be insufficient to allow the user to remove a part with little or no notice, because a static volume could be comprised of billions of samples. This plan would use a higher order volume of “bricks” that correspond to blocks of N×N×N samples of the main volume (where N>1). Each brick would contain a table indicating which parts affect the samples within the brick, allowing the user to quickly determine the effect of a part being removed. In the example above, part C was originally represented in the fixed volume, but after removing part A it becomes the moving part. Instead of re-computing the entire volume, the higher order “brick” volume is queried to determine which of the samples need to be re-computed by comparing the individual volumes of parts B and D.

In the context of haptics, the term fidelity is the extent to which the haptic collision detection approximates a brute-force polygon-by-polygon intersection test. Ultimately, the fidelity of the collision detection needs to be as high as possible. High fidelity permits forces transferred through the haptic device to be as accurate as possible for the environment, and also ensures that no erroneous conclusions are drawn about the ability of a part to move collision-free along a particular path. Generally, there is no need to do collision detections more often than 1000 times per second, though doing each point test faster allows the ability to test more points, resulting in higher fidelity. Increased fidelity reduces discontinuities in the forces felt on the haptic device.

In a further embodiment, the technician is immersed in a virtual environment. FIG. 3 shows an embodiment of a haptics interface including head-mounted display capable of tracking head movement while viewing a three-dimensional scene, allowing the scene to move naturally. High graphic rendering speed is generally required to avoid motion sickness by the user (also, minimal tracking lag time and high sampling rate of the tracking device are generally required). Head movement tracking is employed as a means to change the display environment. Desirably, validation unit 140 is adapted to limit the amount of unnecessary graphics updates to avoid scene re-renders with every insignificant head movement, similar to the anti-shake feature in a video camcorder. To track the users hand and arm movement in the virtual environment, data glove technology (Virtual Technologies data glove, for example) and body tracking technology (Ascension Technologies flock of birds, for example) are desirably included in validation unit 140. These technologies enable users to see their hands and arms in the virtual environment as the maintenance task is being performed. Finally, the haptics environment is continuously monitored and the static position of the haptics device end effector (the “end effector” is the part of the haptic device that the user grasps, usually an ordinary handle, but could conceivably be a mock-up of a moving part in the virtual environment) is updated as it simulates the part to be removed. Since these maintenance scenarios require multiple parts to be removed in an undefined order, the location of the hand as it reaches out to grasp the part and position the haptics device end effector are tracked appropriately. To accomplish realism from a visual perspective, the tracking of hand motion (finger joints, etc.) will end when the virtual hand has come in contact with the object in the virtual environment. Otherwise, the user's virtual hand would penetrate the object in the environment. Alternatively, other available technologies such as a CyberGrasp type device may be employed. This type of device permits forces to be individually applied to each finger, thus fingers could be stopped instead of allowing the hand to continue to close.

Referring further to FIG. 1, computing environment or system 100 further includes instruction delivery unit 150. Embodiments for delivery unit 150 include voice instructions, written instructions (e.g. service manual), animated video instructions as well as web-based virtual training instructions. The instructions are acquired from the processes described above with reference to service sequence generator 120, automated task order generator 130 and validation unit 140. Delivery unit 150 is adapted to convey the instructions, in the desired format (written, voice, web-based virtual, or video) for enabling field service maintenance personnel to perform the desired maintenance task or tasks. Alternatively, delivery unit 150 conveys training information. The format of the instructions for a particular task is selectable by the technician. For example, the technician may select voice instructions or written instructions for a given task. System 100 is further adapted to permit technician feedback to engineering data generator 110. As maintenance tasks are performed, the technician is permitted to convey feedback in the form of alternative or updated task sequences via delivery unit 150 to engineering data generator 110. Feedback from field service personnel is incorporated into engineering data, thus benefiting future engineering design activities and technical documentation generation. Technician feedback is desirably included in engineering data that is used to generate technical documentation or other task order media for future products that are technically close to the new product (often known as a “make from”).

From the present description, it will be appreciated by those skilled in the art that the methods and systems are universally applicable, regardless of language of the engineering data.

The flow diagrams depicted herein are examples only. There may be many variations to these diagrams or steps (or operations) described therein without departing from the spirit of the invention. For instance, the steps may be performed in a differing order, or steps may be added, deleted or modified. All of these variations are considered a part of the claimed invention.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A computer-implemented method for generating at least one disassembly sequence from a geometric representation of an assembly, said method comprising:
generating said at least one disassembly sequence responsive to selection of at least one part for removal from said assembly based on a plurality of pre-computed relational information from said geometric representation.

2. The method of claim 1 wherein said pre-computed relational information comprises at least one of mating interfaces between respective parts of said assembly, non-directional blocking graphs, and relative ordering and groupings of parts within said assembly.

3. The method of claim 1 further comprising converting said disassembly sequence into human-readable instructions for use in at least one of a service event, a maintenance task and training.

4. The method of claim 1 wherein said generating step further comprises:
identifying a location of said at least one part selected for removal;
identifying at least one part impeding removal of said at least one part selected for removal; and,
adding said at least one impeding part to said disassembly sequence.

5. The method of claim 4 further comprising repeating identifying a plurality of parts impeding removal of said at least one part selected for removal and adding said plurality of impeding parts to said disassembly sequence.

6. The method of claim 1 wherein the generating step employs heuristics to generate said at least one disassembly sequence.

7. The method of claim 6 wherein said heuristics comprises at least one of user specified constraints, part connectivity information and part symmetry information.

8. A computer implemented method for generating at least one disassembly sequence from a geometric representation of an assembly, said method comprising:
computing mating interfaces and blocking graphs between respective parts of said assembly based on said geometric representation;
computing removal orders for a plurality of parts contained in said assembly based on said mating interfaces and blocking graphs;
selecting at least one part for removal from said assembly;
computing disassembly paths for a plurality of parts impeding removal of said at least one selected part; and,
generating said at least one disassembly sequence for said at least one part based on said mating interfaces and blocking graphs, respective removal orders and disassembly paths.

9. The method of claim 8 further comprising converting said disassembly sequence into human-readable instructions for use in at least one of a service event, a maintenance task and training.

10. The method of claim 8 wherein said disassembly sequence is used by service personnel in at least one of performing maintenance of equipment and training.

11. The method of claim 8 wherein the generating step employs heuristics to generate said at least one disassembly sequence.

12. The method of claim 11 wherein said heuristics comprises at least one of user specified constraints, part connectivity information and part symmetry information.

13 A system for generating at least one disassembly sequence from a geometric representation of an assembly, said system comprising:
an engineering data generating device adapted to compute and provide engineering data relating to said assembly;
a service sequence generator adapted to import and process said engineering data to generate at least one disassembly sequence responsive to selection of a part for removal from said assembly.

14. The system of claim 13 wherein said service sequence generator is adapted to generate at least one additional disassembly sequence responsive to selection of an additional part for removal from said assembly.

15. The system of claim 13 wherein said at least one disassembly sequence is used by service personnel in at least one of performing maintenance of equipment and training.
